(19) United States
(12) Patent Application Publication
(10) Pub. No.: US 2017/0261965 A1
(43) Pub. Date: Sep. 14, 2017

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Takeshi Shiihara, Kawasaki-shi (JP)

(21) Appl. No.: 15/451,030

(22) Filed: Mar. 6, 2017

(30) Foreign Application Priority Data
Mar. 11, 2016 (JP) 2016-048863

(51) Int. Cl. G05B 19/4099

(52) U.S. Cl. CPC G05B 19/4099; G05B 2219/49023

(57) ABSTRACT

An information processing apparatus that manages information about a plurality of modeling apparatuses each of which models a three-dimensional object acquires setting information indicating a setting for modeling to a modeling apparatus having received an instruction for modeling of an object, acquires performance information indicating a function concerning modeling that is able to be provided by an alternative modeling apparatus other than the modeling apparatus having received the instruction, determines whether the setting for modeling is able to be applied to the alternative modeling apparatus based on the acquired performance information about the alternative modeling apparatus in order to cause the alternative modeling apparatus to model the object concerning the instruction, and controls displaying of information indicating a result of determining whether the setting for modeling is able to be applied to the alternative modeling apparatus.

### BACKGROUND

Field of the Disclosure

Aspects of the present disclosure generally relate to information processing and, more particularly, to an information processing apparatus, a control method, and a storage medium concerning modeling performed by a modeling apparatus that models a three-dimensional object.

Description of the Related Art

A modeling apparatus that models a three-dimensional object, which is a solid object, based on model data is generally called a three-dimensional (3D) printer, and, in recent years, 3D printers have rapidly become widespread. The technology concerning three-dimensional modeling is also called “additive manufacturing”. In contrast to this, a two-dimensional (2D) printer refers to a printing apparatus that performs printing on, for example, paper (sheet).

Examples of the modeling method used by 3D printers include a fused deposition modeling (FDM) method and a stereo lithography (STL) method. Furthermore, the examples also include a selective laser sintering (SLS) method and an inkjet method. Consumable materials adapted for these modeling methods are used to model an object. Examples of a configuration for supplying a consumable material to a 3D printer include a configuration of loading a dedicated cartridge, a configuration of using a filament-like material wound around a core, and a configuration of using a container, such as a bottle, containing a liquid or powdery consumable material.

To perform modeling using the above-mentioned 3D printer, a job containing information about modeling setting, which is a setting for modeling to the 3D printer, is sent to the 3D printer. The modeling setting refers to the setting for modeling specified to the 3D printer at the time of modeling by the 3D printer. More specifically, the modeling setting includes, for example, the movement speed of a head, which outputs a consumable material, and the stacking pitch (layer height), which indicates the stacking width of the consumable material output from the head. After the job containing information about modeling setting is sent to the 3D printer, modeling may be interrupted due to the occurrence of a malfunction of the 3D printer. In particular, in a case where a malfunction occurs in a hardware component used for modeling, such as a drive motor, a heat-applying heater, or an extruder, a long time to repair or replace the failed component may occur, so that it is difficult to resume modeling. If a long time for resumption of modeling takes place, a delay may occur in scheduling of post-process tasks, such as polishing, assembling, and shipping of a modeled object. Therefore, using another 3D printer serving as an alternative machine to perform modeling can be considered.

Japanese Patent Application Laid-Open No. 2007-87130 discusses a method of, in a case where a designated printing apparatus is unable to perform printing, specifying a candidate for an alternative printing apparatus that instead executes a print job. With respect to a plurality of printing apparatuses, a sever manages attributes, such as color/monochrome availability, supported paper sizes, and two-sided printing availability. The user specifies the order of priority about the attributes, and the server determines, as an alternative machine, a printing apparatus in which, with respect to a higher priority attribute, the attribute thereof coincides with the attribute of the printing apparatus unable to perform printing.

The above-mentioned Japanese Patent Application Laid-Open No. 2007-87130 does not deal with any 3D printer. Furthermore, with respect to the printing apparatus unable to perform printing and the printing apparatus serving as an alternative machine, the attributes indicating functions concerning printing are compared with each other between these apparatuses. Therefore, Japanese Patent Application Laid-Open No. 2007-87130 does not discuss a technique for finding an alternative machine according to settings for modeling, such as setting items or setting values thereof included in an initial instruction for modeling from the user.

Here, settings usable for modeling, such as setting items concerning modeling, values settable for the respective setting items, and ranges of settable values, supported by 3D printers vary depending on models of 3D printers. It is troublesome for the user to examine performance information indicating functions concerning modeling while referring to the manual in order to find out an alternative machine to which the settings for modeling to the 3D printer that has become unable to perform modeling are able to be applied. Moreover, even in the case of an alternative machine to which a part of the settings for modeling is not able to be applied, if there is only a small influence on the finish of a modeled object, the part of the settings may be changed in such a way as to become able to be applied to the alternative machine. In such a case, it is difficult for the user to comprehend, for example, an item of setting to be changed.

### SUMMARY

Aspects of the present disclosure generally relate to providing a contrivance for displaying information indicating whether a setting for modeling to a modeling apparatus having received an instruction for modeling is able to be applied to another alternative modeling apparatus.

According to one or more aspects of the present disclosure, an information processing apparatus is configured to manage information about a plurality of modeling apparatuses each of which models a three-dimensional object, the information processing apparatus including one or more processors, and one or more memories storing a program which, when executed by the one or more processors, causes the information processing apparatus to: acquire setting information indicating a setting for modeling to a modeling apparatus having received an instruction for modeling of an object; acquire performance information indicating a function concerning modeling that is able to be provided by an alternative modeling apparatus other than the modeling apparatus having received the instruction; determine whether the setting for modeling indicated by the acquired setting information is able to be applied to the alternative modeling apparatus based on the acquired performance information about the alternative modeling apparatus in order to cause the alternative modeling apparatus to model the object concerning the instruction; and control displaying of information indicating a result of determining whether the setting for modeling is able to be applied to the alternative modeling apparatus, wherein, if determining that the setting for modeling is not able to be applied to the alternative modeling apparatus, the information processing apparatus controls displaying of information about the setting for modeling that is not able to be applied to the alternative modeling apparatus.

Further features of the present disclosure will become apparent from the following description of exemplary embodiments with reference to the attached drawings.

### BRIEF DESCRIPTION OF THE DRAWINGS

FIG. 1 illustrates an example of a system configuration of a network system according to an exemplary embodiment of one or more aspects of the present disclosure.

FIG. 2 illustrates a hardware configuration example of information processing functions according to one or more aspects of the present disclosure.

FIG. 3 illustrates a software configuration example of the network system according to one or more aspects of the present disclosure.

FIG. 4 illustrates configuration examples of tables in a data management module according to one or more aspects of the present disclosure.

FIG. 5 is a flowchart illustrating an example of the flow of processing performed by a client application according to one or more aspects of the present disclosure.

FIGS. 6A and 6B are flowcharts illustrating examples of sub-flows illustrated in FIG. 5 according to one or more aspects of the present disclosure.

FIG. 7 illustrates an example of a display screen user interface (UI) for a modeling job execution error according to one or more aspects of the present disclosure.

FIG. 8 illustrates an example of a display screen UI for a list of modeling apparatuses appropriately adaptable to an existing model setting according to one or more aspects of the present disclosure.

FIG. 9 illustrates an example of a display screen UI for modeling setting confirmation according to one or more aspects of the present disclosure.

FIG. 10 illustrates an example of a display screen UI for modeling setting change according to one or more aspects of the present disclosure.

FIG. 11 is a flowchart illustrating an example of the flow of processing performed by the client application according to one or more aspects of the present disclosure.

FIG. 12 illustrates an example of a display screen UI for execution job selection according to one or more aspects of the present disclosure.

FIG. 13 is a flowchart illustrating an example of the flow of processing performed by the client application according to one or more aspects of the present disclosure.

FIG. 14 illustrates an example of a display screen UI for work process procedure data output according to one or more aspects of the present disclosure.

### DESCRIPTION OF THE EMBODIMENTS

Various exemplary embodiments, features, and aspects of the disclosure will be described in detail below with reference to the drawings.

Furthermore, while the following exemplary embodiments are described mainly with a 3D printer employing the FDM method taken as an example, modeling apparatuses include 3D printers that perform modeling using the methods other than the FDM method, such as the stereo lithography method or the selective laser sintering method.

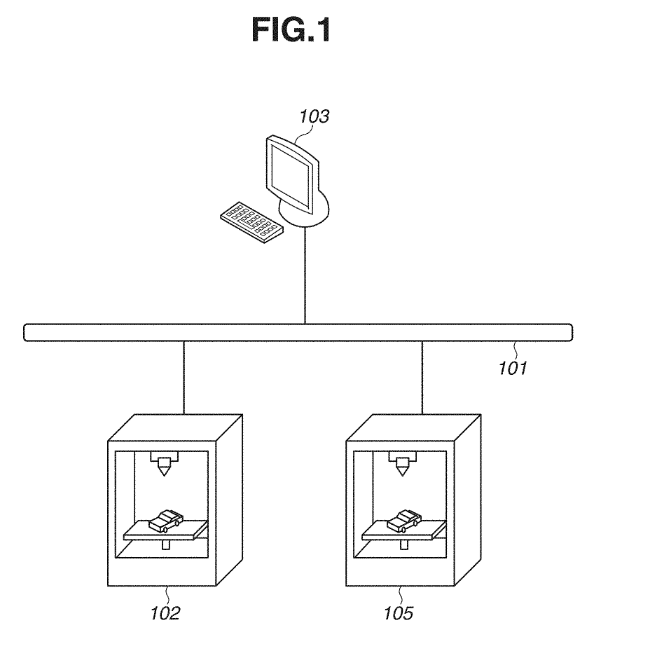

FIG. 1 illustrates an example of a system configuration of a network system according to a first exemplary embodiment of the present disclosure.

A network 101 is, for example, an intranet or a local area network (LAN). A 3D printer 102 is an example of a modeling apparatus capable of modeling a three-dimensional object based on 3D model data. A computer 103 is a client computer on which modeling control software is installed. Furthermore, the computer 103 can include a function operating as a management server on which a 3D printer management application runs. Examples of types of the computer 103 include a personal computer (PC), a tablet computer, and a smartphone.

The 3D printer 102, a 3D printer 105, and the computer 103, which constitute a management system in the present exemplary embodiment, are able to mutually transmit and receive information via the network 101. Furthermore, the network 101 can be a wireless network, such as a wireless LAN. Moreover, the network 101 can be a public network, such as the Internet, as long as it is capable of transmitting and receiving information.

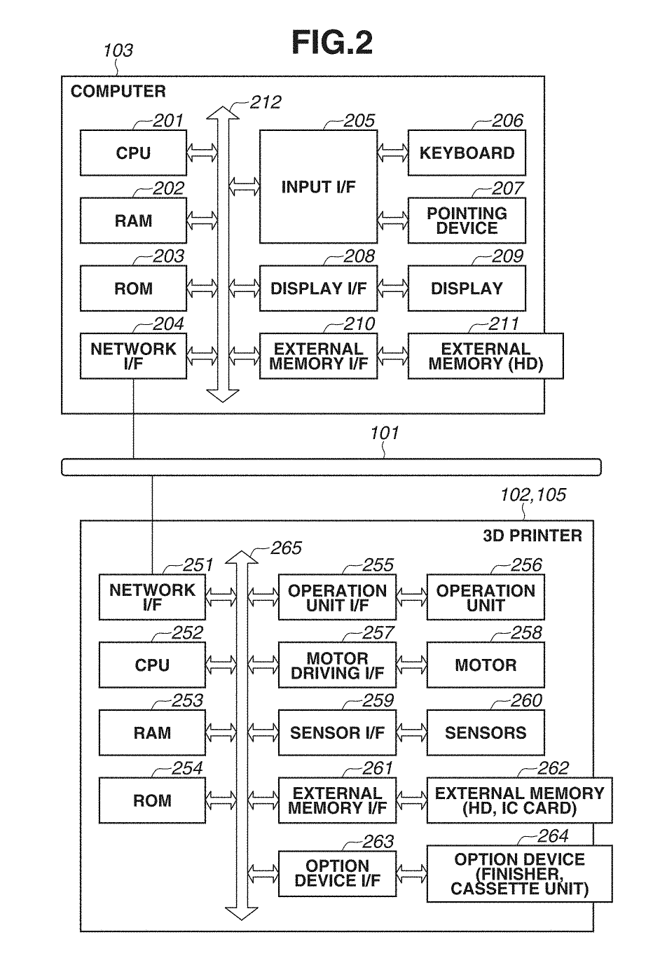

FIG. 2 illustrates a hardware configuration example of information processing functions of the 3D printer 102 or 105 and the computer 103. The network system is configured with the computer 103 and the 3D printers 102 and 105, which are connected by the network 101. Furthermore, the computer 103 has a configuration operating as a general-purpose computer.

In the computer 103, a central processing unit (CPU) 201, which may include one or more processors and one or more memories, performs processing based on, for example, an application program stored in a read-only memory (ROM) 203 or an external memory 211, and comprehensively controls various devices connected to a system bus 212. Moreover, the CPU 201 opens various registered application windows based on commands specified by, for example, a mouse or cursor (not illustrated) displayed on a display 209, and performs various data processing operations.

A random access memory (RAM) 202 functions as, for example, a main memory or work area for the CPU 201. The ROM 203 is memory that is read-only functioning as a storage region, for example, for a basic input-output (I/O) program. For example, an operating system program (OS), which is a control program for the CPU 201, is stored in the ROM 203 or the external memory 211. Moreover, files and other pieces of data, which are used for processing performed based on, for example, the above-mentioned application program, are stored in the ROM 203 or the external memory 211.

A network interface (I/F) 204 connects to the network 101 to perform network communication. An input I/F 205 controls inputs from a keyboard 206 and a pointing device 207, such as a mouse. A display I/F 208 controls displaying performed on the display 209. An external memory I/F 210 controls access to the external memory 211, such as a hard disk (HD).

The external memory 211 stores, for example, a boot program, various applications, user files, and editing files. The computer 103 operates in a state in which the CPU 201 is executing the basic I/O program and the OS written to the ROM 203 or the external memory 211. The basic I/O program is written in the ROM 203, and the OS is written in the ROM 203 or the external memory 211. Then, when the computer 103 is powered on, the OS is written from the ROM 203 or the external memory 211 to the RAM 202 by an initial program loading function included in the basic I/O program, so that the operation of the OS is started. The system bus 212 interconnects various devices.

In each of the 3D printers 102 and 105, a network I/F 251 connects to the network 101 to perform network communication. A CPU 252 outputs a control signal serving as output information to a motor 258 via a motor driving I/F 257 connected to the system bus 265 based on, for example, a control program. Furthermore, the control program is stored in, for example, a ROM 254 or an external memory 262. The CPU 252 is capable of performing communication processing with the computer 103 via the network I/F 251, and is thus configured to notify the computer 103 of, for example, information stored in the 3D printer 102 or 105. Moreover, the CPU 252 performs processing based on, for example, an application program stored in the ROM 254 or the external memory 262.

A RAM 253 functions as, for example, a main memory or work area for the CPU 252, and is configured to be able to expand the memory capacity with an option RAM connected to an expansion port (not illustrated). Furthermore, the RAM 253 is used as, for example, an output information loading region, an environmental data storage region, or a non-volatile random access memory (NVRAM). For example, a control program and an application program for the CPU 252, font data to be used during generation of the output information, and information to be used on the 3D printer 102 or 105 are stored in the ROM 254 or the external memory 262. Moreover, an application is temporarily stored in the ROM 254 or the external memory 262 when the application is installed on the 3D printer 102 or 105.

An operation unit I/F 255 serves as an interface with an operation unit 256, and outputs image data to be displayed to the operation unit 256. Moreover, the operation unit I/F 255 receives information input by the user via the operation unit 256. The operation unit 256 corresponds to, for example, an operation panel on which, for example, switches for operation and light-emitting diode (LED) display devices are arranged. The motor driving I/F 257 outputs a control signal as output information to the motor 258 (driving part). A sensor I/F 259 receives signals as input information from sensors 260 (for example, a temperature sensor, a vibration sensor, and an object identification sensor). Moreover, the sensors 260 further include a sensor that detects the remaining amount of a consumable material in a cartridge set in the 3D printer 102 or 105.

Furthermore, the cartridge in which a consumable material is stored can be of the interchangeable type or of the type in which the same cartridge is replenished with a consumable material. Moreover, the cartridge in which a consumable material is stored does not need to have a detection unit that detects the attachment of the cartridge to the 3D printer. Additionally, examples of the form in which a consumable material is stored in a cartridge include the type in which a filament-like material is wound around a core and the type in which a liquid or powdered consumable material is contained in a container such as a bottle. Furthermore, the consumable material in the present disclosure includes, for example, a material used for an object and a material used for a support that is modeled when needed as a bearing during modeling.

An external memory I/F (memory controller) 261 controls access to the external memory 262, such as a hard disk (HD) or an integrated circuit (IC) card. Furthermore, the external memory 262 is not limited to a single memory, but can include at least one memory and can be configured to be connectable to an option font card in addition to a built-in font or a plurality of external memories storing a program for interpreting printer control languages having different language systems. Additionally, the external memory 262 can include an NVRAM and can store printer mode setting information input from the operation unit 256.

An option device I/F 263 controls access to an option device 264. The option device 264 includes, for example, an ancillary facility that may be used depending on the modeling method and a peripheral device for expanding the function and mechanism of the 3D printer, such as a camera or an IC card reader. Examples of the ancillary facility may include a device as a measure against powder in the case of the inkjet method and a washing apparatus in the case of stereo lithography (SLA). The system bus 265 interconnects various devices.

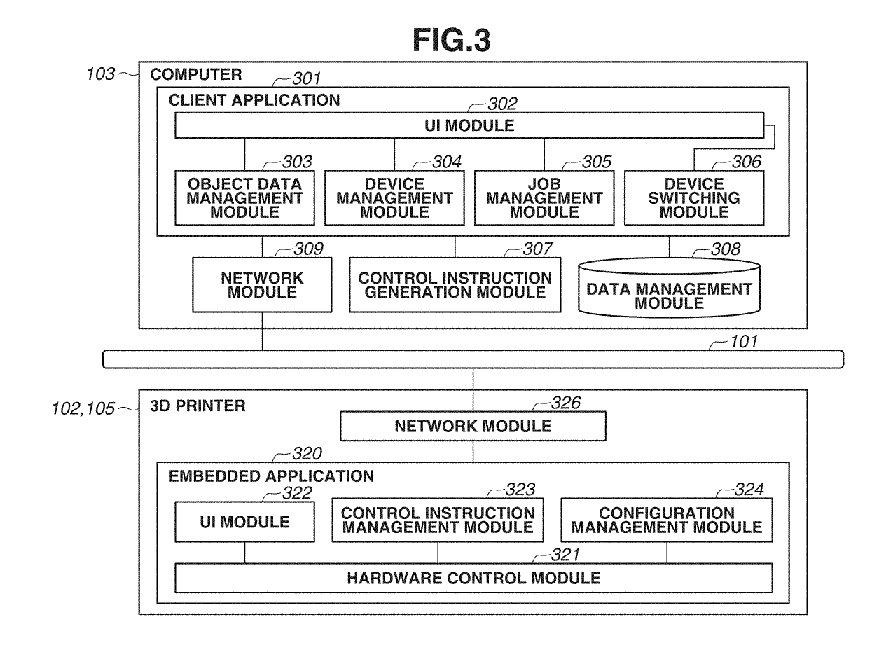

FIG. 3 illustrates a software configuration of the network system. Software configurations of the 3D printers 102 and 105 and the computer 103, which perform communications via the network 101, are described with reference to FIG. 3. In the following description, the term “device” refers to a 3D printer, which is an example of a modeling apparatus.

First, a software configuration of the computer 103 is described. In the computer 103, a client application 301 and various modules exist as files stored in the external memory 211. These are program modules that are loaded on the RAM 202 by the OS or modules using those modules and executed thereby.

Furthermore, the client application 301 is able to be added to a compact disc read-only memory (CD-ROM) of the external memory 211 or to an HD of the external memory 211 via the network 101. A network module 309 performs network communication with the 3D printer 102 or 105 or another computer (not illustrated) using an optional communication protocol. Furthermore, an information processing apparatus in which the client application 301 runs can be other than the computer 103, and can be, for example, a computer incorporated in the 3D printer 102 or 105 or a computer in which a 3D printer management application runs.

A user interface (UI) module 302, which is included in the client application 301, is a module that provides a graphical interface to the user. For example, the UI module 302 invokes an application window, draws 3D model data, and displays various setting screens. Besides, the UI module 302 can provide an interface used to operate an application according to a protocol, such as HyperText Transfer Protocol (HTTP), in response to a request from an external device via the network 101 and a network module 309. Furthermore, a graphical user interface (GUI) operation unit can be provided to the user by another method. Moreover, the UI module 302 provides various functions to the user by invoking and executing various modules.

Examples of modules to be invoked by the UI module 302 include an object data management module 303, a device management module 304, a job management module 305, and a device switching module 306. Furthermore, the UI module 302 can invoke a module other than these modules.

The object data management module 303 is a module that manages object data (3D model data) input via the UI module 302. Examples of a file format of the object data include a standard triangulated language (STL) format. STL is a file format for storing data that expresses a three-dimensional shape, and is often used as a file type of 3D model data. Furthermore, the file type of object data can be other than STL as long as it is a file format for expressing a three-dimensional shape.

The device management module 304 searches for the 3D printer 102 connected to the computer 103 via the network 101 using an optional communication protocol. Examples of the communication protocol used for search by the device management module 304 include Internet Printing Protocol (IPP) and Web Services Dynamic Discovery (WS-Discovery).

Besides, other communication protocols, such as Simple Network Management Protocol (SNMP) and Service Location Protocol (SLP), can also be used. The device management module 304 searches for the 3D printer 102, acquires, for example, modeling setting information, modeling performance information, the remaining amount of a consumable material, progress information about a job, and state information about the device from the 3D printer 102, and stores the acquired pieces of information in a data management module 308 described below.

The job management module 305 generates and manages a job including object data received by the UI module 302 and the object data management module 303 and a control instruction generated based on the modeling setting information received by the device management module 304. The term “modeling setting” refers to a setting for modeling specified with respect to a 3D printer at the time of modeling by the 3D printer. More specifically, the modeling setting includes, for example, the movement speed of a head, which outputs a consumable material, and the stacking pitch, which indicates the stacking height of the consumable material output from the head. The control instruction is information generated by a control instruction generation module 307, described below, based on the object data and the modeling setting. The generated job is transmitted to the 3D printer 102 via the network module 309 and the network 101.

Furthermore, the job management module 305 analyzes the control instruction, and calculates the usage of a consumable material for modeling by the 3D printer according to the modeling setting. It is determined whether the job is able to be executed based on information about the calculated usage. Furthermore, the job management module 305 can be configured to be able to perform an operation other than transmission of a job and determination of whether the job is executable, and, for example, can reserve the execution of a job by defining the date and time of execution of the job according to schedule.

The device switching module 306 determines whether modeling setting of a modeling job generated by the job management module 305 is able to be applied to another modeling apparatus, and provides a list screen of modeling apparatuses to the user. A modeling apparatus that is able to be used can be found by the device management module 304 searching for the 3D printer 102 or 105 on the network 101 using Transmission Control Protocol/Internet Protocol (TCP/IP), or information about modeling apparatuses can be previously registered with the client application 301. Examples of items of the modeling setting include the infill density, infill pattern, scale size, and consumable material type of an object. Furthermore, other types of setting information can be used as long as they relate to modeling performed by a 3D printer.

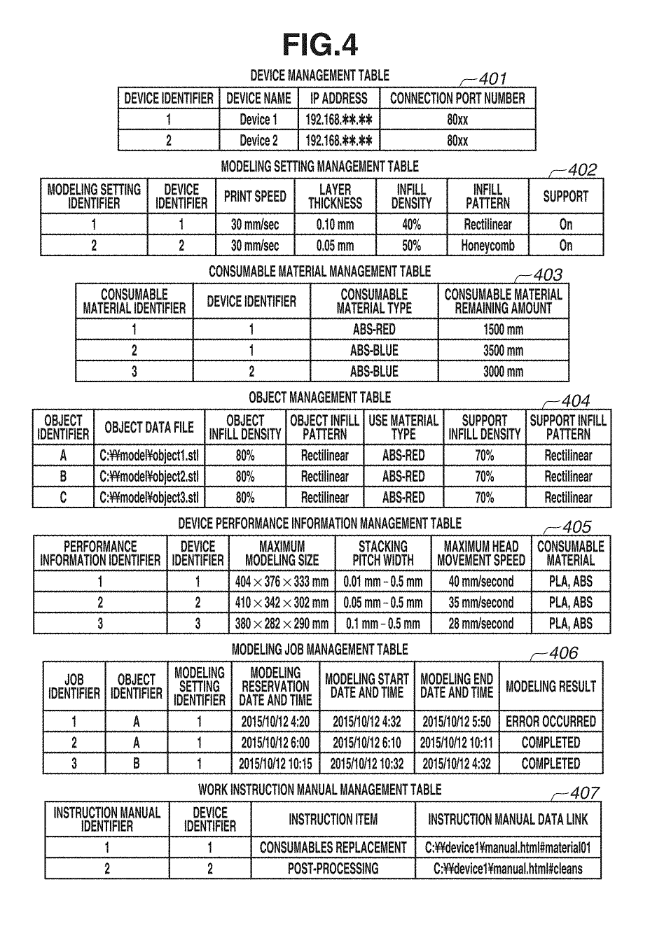

The data management module 308 manages various pieces of data and files and performs storage and fetch of data in response to a request from another module. The data management module 308 may be located on an apparatus that is other than the computer 103 and is able to be accessed by the client application 301. Data to be managed by the data management module 308 is described below with reference to FIG. 4.

The control instruction generation module 307 is one of modules of modeling control software, which is installed on and executed by the computer 103. The control instruction generation module 307 converts object data into an instruction format executable by a 3D printer. For example, the control instruction to be used is a file of the format obtained by expanding, for example, a machine tool instruction called “G-code” so as to be used for 3D printers. Furthermore, the client application 301 itself can incorporate the control instruction generation module 307.

Next, a software configuration of the 3D printer 102 is described. In the 3D printer 102, various modules exist as files stored in the ROM 254 or the external memory 262 and are loaded on the RAM 253 during execution and then executed. A network module 326 performs network communication with the computer 103 using an optional communication protocol. An embedded application 320 is an application that is loaded on the RAM 253 and executed. The embedded application 320 is configured with a group of modules including, for example, a hardware control module 321, a UI module 322, a control instruction management module 323, and a configuration management module 324, which are described below. Furthermore, the embedded application 320 can include a module for the 3D printer to perform modeling.

The hardware control module 321 controls various drive components of the 3D printer and acquires values from various sensors (not illustrated), such as a temperature sensor and a vibration sensor. The hardware control module 321 receives control instructions about modeling from the UI module 322, the control instruction management module 323, and the configuration management module 324, which are described below, and transmits feedback information, such as sensor values, to the respective modules. Furthermore, the control about modeling is not limited to these examples.

The UI module 322 is a module that outputs information about modeling by a 3D printer to the operation unit 256 of the 3D printer 102 and receives control instructions and various pieces of setting value information. For example, the UI module 322 performs processing including, for example, outputting progress information about modeling to a panel attached to the 3D printer and displaying content of an error in the case of the occurrence of such error. Moreover, the UI module 322 can receive processing including, for example, changing setting values of the 3D printer via, for example, a panel screen and buttons. Additionally, the UI module 322 can perform processing including, for example, receiving a control instruction via an external memory, such as a universal serial bus (USB) memory, and can be configured to be able to provide the UI of the 3D printer to the outside according to a web protocol, such as HTTP protocol, received from the outside via the network module 326. Furthermore, the input and output of information about modeling are not limited to these examples.

The control instruction management module 323 is a module that receives, manages, and executes a control instruction transmitted from the client application 301. The control instruction management module 323 performs storage, change, and deletion of a control instruction included in job data transmitted from the client application 301 and performs management of information about a job. For example, the control instruction management module 323 manages actual modeling processing by updating progress information (for example, start, end, or error) about a plurality of jobs received from the client application 301, reading a control instruction, and operating various drive components via the hardware control module 321. Moreover, the control instruction management module 323 can include the function of the control instruction generation module 307 of the client application 301 depending on the model performance of the 3D printer 102, convert object data into a control instruction on the 3D printer, and manage and execute the generated control instruction. Furthermore, the control about management of a control instruction is not limited to these examples.

The configuration management module 324 manages hardware configuration information and software configuration information about the 3D printer 102 and status information about various consumable materials and components. Examples of the hardware configuration information include unique information about the 3D printer 102 itself, such as a product serial number of the 3D printer 102 itself and a manufacturing plant identifier, and product information and usage status about an optional device connected to the 3D printer 102. Examples of the optional device include a finisher and a cassette unit. In a case where a consumable material or a consumable or abrasive component, such as a hinge, is used inside the optional device, the configuration management module 324 also acquires the consumption state and the abrasion state of such a material or component, and notifies the client application 301 of the acquired states via the network module 326 and the network 101. Examples of the software configuration information include firmware information about the 3D printer 102 and information about installed applications. Moreover, the configuration management module 324 can receive an update request for firmware transmitted from the client application 301 and perform firmware updating of the 3D printer 102 itself and installment of an application.

FIG. 4 illustrates configuration examples of tables in the data management module 308. Furthermore, the configurations of tables illustrated in FIG. 4 are merely examples, and can be configurations of tables different from those in these examples.

A device management table 401 is a table used to manage information about the 3D printer 102, which the client application 301 manages. Examples of the information managed with the device management table 401 include a device identifier, a device name, an Internet Protocol (IP) address, and a connection port number. Furthermore, in the following description, a modeling apparatus is in some cases referred to simply as a “device”.

Here, the device identifier is an identifier for uniquely identifying the 3D printer 102. The device name is an optional name enabling identifying the 3D printer 102. The IP address and the connection port number are address information used to connect to the 3D printer 102 and transmit a job and acquire status information.

A modeling setting management table 402 is a table used to manage information about modeling setting associated with each 3D printer information. Examples of items of the information managed with the modeling setting management table 402 include a modeling setting identifier, a device identifier, a print speed, a layer thickness, an infill density, an infill pattern, and support.

Here, the modeling setting identifier is an identifier for uniquely identifying modeling setting. The print speed is a modeling speed of the 3D printer. For example, in the case of a 3D printer of the FDM system, an extrusion speed of a consumable material (filament material) is used as the print speed. The layer thickness refers to a stacking pitch corresponding to the thickness (pitch width) of one layer. The stacking pitch refers to the stacking width of a modeling material output from a head. As the value of the stacking pitch is smaller, a modeled object with a smoother surface can be modeled. The infill density is an infill density of the internal structure of an object. As the infill density is higher, the density of the inside of a modeled object becomes higher and the strength thereof increases, but the usage of a consumable material also increases.

The infill pattern refers to a shape of the internal structure of an object. Examples of the infill pattern include Rectilinear, Concentric, Honeycomb, and Hilbert Curve. The strength and elasticity of a modeled object can be adjusted by the infill pattern.

The support (support structures) is a modeled object (for example, a pillar) that is modeled when needed as a bearing during modeling. In a case where modeling of a support is enabled (turned “on”), a support serving as a bearing at a portion for outputting a material is modeled when needed. Modeling the support enables modeling a distortion-free modeled object. A control instruction for the support is generated by the control instruction generation module 307 according to the structure of an object. In other words, information about a support is not included in object data, and, when the object data is converted into a control instruction, information about modeling of the support is added to the control instruction for an object. Furthermore, the infill density, the infill pattern, and the support can be configured to be able to be set to every object included in a job, or can be configured to be able to be set to some objects. Moreover, the infill density and the infill pattern can be configured to be able to be set to only a portion of the support.

A consumable material management table 403 is a table used to manage consumable material information about the 3D printer 102. Examples of the consumable material information managed with the consumable material management table 403 include a consumable material identifier, a device identifier, a consumable material type, and a consumable material remaining amount.

Here, the consumable material identifier is an identifier for uniquely identifying consumable material information associated with the 3D printer. The consumable material type is information indicating the type of a consumable material, such as material and color. The material of a consumable material to be used differs depending on the modeling method. For example, in the fused deposition modeling (FDM) method, a consumable material such as acrylonitrile-butadiene-styrene (ABS) resin or polylactide (PLA) resin is used. Furthermore, a water-soluble consumable material is in some cases used for the support. Moreover, in a case where modeling is performed with the use of a special powdered material, such as gypsum, and adhesive, the adhesive used for modeling is also included in the consumable material.

The consumable material remaining amount is the remaining amount of a consumable material in the 3D printer 102. The device management module 304 acquires the consumable material type and the consumable material remaining amount from the configuration management module 324 of the 3D printer 102. Furthermore, another method can be used to acquire the consumable material type and the consumable material remaining amount in the 3D printer 102.

An object management table 404 is a table used to manage object data. Examples of information to be managed with the object management table 404 include an object identifier, an object data file, an object infill density, an object infill pattern, a use material type, a support infill density, and a support infill pattern.

Here, the object identifier is an identifier for uniquely identifying object data. The object data file is a file path in which a file of object data is stored. The use material type is the type of a consumable material used for modeling of an object.

A device performance information management table 405 is a table used to manage performance information about a modeling apparatus that is managed by the device management module 304. Examples of information to be managed with the device performance information management table 405 include a performance information identifier, a modeling apparatus identifier, a maximum modeling size, a stacking pitch width, a maximum head movement speed, and a consumable material. The performance information refers to information indicating a function concerning modeling that a modeling apparatus is able to provide.

Here, the performance information identifier is an identifier for uniquely identifying performance information. The maximum modeling size is a maximum three-dimensional size that a modeling apparatus is able to model. The stacking pitch width is a range of stacking pitch that an extruder of the modeling apparatus is able to extrude. The maximum head movement speed is a maximum speed at which a head of the modeling apparatus moves. The consumable material is information about a consumable material that is able to be used by the modeling apparatus. The consumable material information can be a cartridge type number of the consumable material or can be, for example, the name of a resin material, such as PLA or ABS.

A modeling job management table 406 is a table used to record and manage information about a job generated by the job management module 305. Examples of information to be managed with the modeling job management table 406 include a job identifier, an object identifier, a modeling setting identifier, a modeling reservation date and time, a modeling start date and time, a modeling end date and time, and a modeling result.

Here, the job identifier is an identifier for uniquely identifying job information. The modeling reservation date and time is the date and time at which the user registered a job with the client application 301. The modeling reservation date and time can be the date and time at which a job was transmitted to a modeling apparatus. The modeling start date and time is the date and time at which a modeling apparatus started modeling processing. The date and time at which modeling processing was determined to be started can be the date and time at which a modeling apparatus received a job or can be the date and time at which extrusion of a consumable material was started. The modeling end date and time is the date and time at which a modeling apparatus ended model processing. The modeling result is information indicating whether a modeling apparatus completed modeling processing. In a case where an error occurs in the middle of modeling, error information can be acquired from the modeling apparatus and an error code or error message can be stored. Moreover, as information to be managed with the modeling job management table 406, the date and time of start and end of warm-up processing of a modeling apparatus or the status information about sensors able to be acquired by the configuration management module 324 of the modeling apparatus 102 can be managed. Examples of the status information about sensors include temperature, humidity, rotational speed of a driving component, and power consumption value. Naturally, besides, values of sensor information for management of a modeling apparatus can also be managed.

A work instruction manual management table 407 is a table used to manage work procedure data of each modeling apparatus. The work procedure data refers to information about a work procedure of pre-processing or post-processing of modeling in a specific modeling apparatus. The work procedure data can be of the hyper-text format, such as HyperText Markup Language (HTML). Naturally, the work procedure data can also be managed with an external database server or another method. Examples of information to be managed with the work instruction manual management table 407 include an instruction manual identifier, a modeling apparatus identifier, an instruction item, and an instruction manual data link.

Here, the instruction manual identifier is an identifier for uniquely identifying work procedure data of a modeling apparatus. The instruction item is work item information indicating a summary of work procedure information. The instruction item can be, for example, a character string of alphanumeric characters as long as it is of the format associated with optional work procedure data. The instruction manual data link is a file address of work procedure data associated with the instruction item. Naturally, the instruction manual data link can be text information or connection information to an external server as long as it is that of work procedure data associated with the instruction item.

Thus far is the description made with reference to FIG. 4.

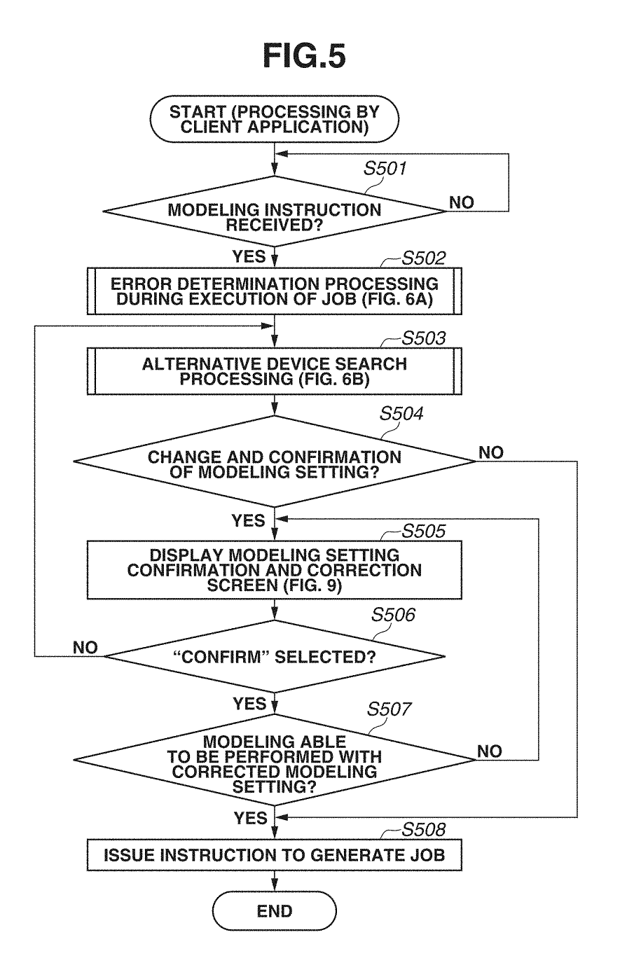

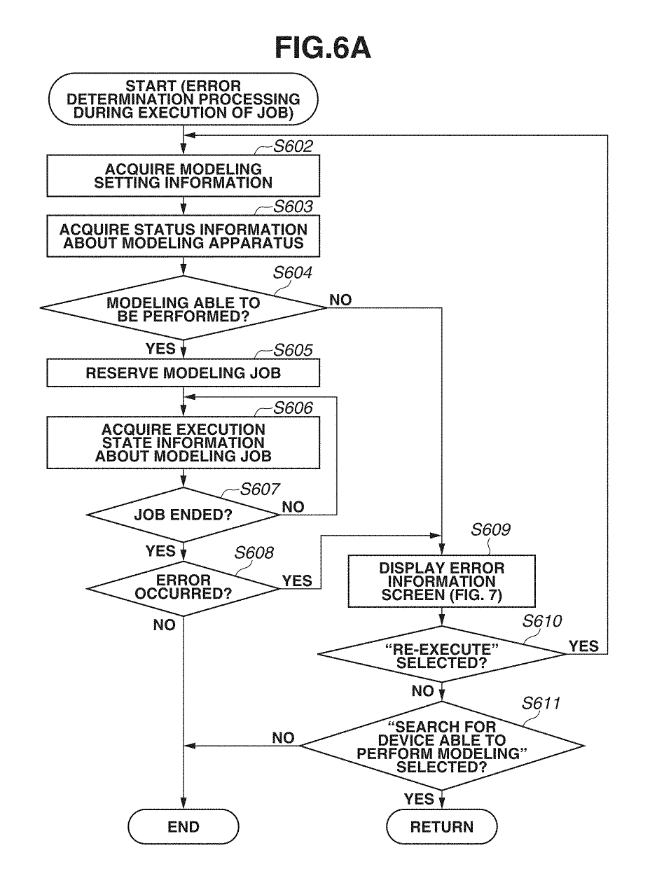

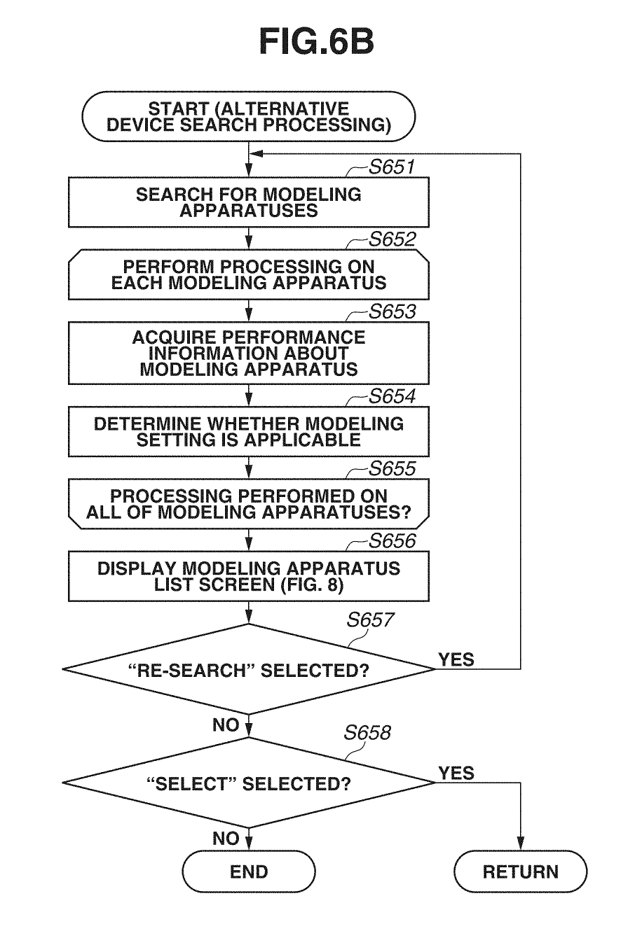

FIG. 5 is a flowchart illustrating the flow of processing performed by the client application 301. This processing is processing performed by the client application 301 before a job to be executed by the modeling apparatus 102 is generated and the job is then executed by the modeling apparatus 102. The processing illustrated in FIG. 5 and FIGS. 6A and 6B, which are described below, is implemented by the CPU 201 reading out a program recorded on the ROM 203 or the external memory 211 and executing the program.

If, in step S501, the job management module 305 of the client application 301 determines that a modeling instruction has been received (YES in step S501), the processing proceeds to step S502. The modeling instruction contains, for example, object data, which indicates a modeling target, and information about device setting and modeling setting. The object data is 3D model data expressed in, for example, the STL system. Examples of the method for receiving the object data include a method of importing a file from the GUI screen of the client application 301 and a method of importing a file from an external application via a network. Furthermore, the received object data is stored in the object management table 404 of the data management module 308.

Furthermore, the received object data may be changed in, for example, the shape or scale size of an object by an operation performed on the GUI screen of the client application 301. Moreover, the device setting or modeling setting of the 3D printer 102 may be changed. The device setting refers to connection setting of a modeling apparatus stored in, for example, the device management table 401 of the data management module 308. The modeling setting contains, for example, setting items, such as print speed, layer thickness, infill density, infill pattern, and support, and values set to these items of the 3D printer 102, which are stored in the modeling setting management table 402 of the data management module 308. In a case where the shape or scale size of an object or the device setting or modeling setting has been changed, the modeling instruction received in step S501 contains the content of the changed data or setting.

In step S502, the job management module 305 performs execution of a job and determination processing in a case where an error occurs during execution of the job. Details of the error determination processing during execution of a job are described with reference to the sub-flow illustrated in FIG. 6A.

In step S602, the job management module 305 acquires modeling setting information from the modeling setting management table 402 of the data management module 308. The modeling setting information is modeling setting information concerning a modeling apparatus previously specified by the user.

In step S603, the device management module 304 connects to the configuration management module 324 of the modeling apparatus 102 via the network modules 309 and 326 and acquires status information about a modeling apparatus. Examples of the status information about a modeling apparatus include information indicating whether, for example, the consumable material type, the consumable material remaining amount, and the in-chassis temperature of the modeling apparatus have reached the respective values available for starting modeling and information indicating whether a job for modeling is in progress.

In step S604, the job management module 305 determines whether the job is able to be executed by the modeling apparatus 102 based on the status information about a modeling apparatus acquired in step S603. More specifically, for example, in a case where the consumable material usage to be consumed by the job does not exceed the consumable material remaining amount of the modeling apparatus 102, in a case where there is no abnormality in any sensor and driving component of the modeling apparatus 102, or in a case where there is no job that is being executed and a reservation is able to be made, the job management module 305 determines that modeling is able to be performed (YES in step S604), the processing proceeds to step S605. In a case where another job is being executed and a new reservation of a job is not able to be made, in a case where the consumable material is estimated to run short during modeling, or in a case where an abnormality is detected in some sensor or driving component, the job management module 305 determines that modeling is not able to be performed (NO in step S604), the processing proceeds to step S609. At this time, the job management module 305 stores execution result information about the job together with error information in the modeling job management table 406.

In step S605, the job management module 305 reserves execution of the job at the modeling apparatus 102. At this time, even if the modeling apparatus 102 is being executing another job, the job management module 305 can be configured to make a reservation in such a manner that the modeling apparatus 102 stores job information and executes the stored job at optional timing.

In step S606, the job management module 305 acquires execution state information about the job from the hardware control module 321 of the modeling apparatus 102. As a method of acquiring the execution state information about the job, for example, a standard protocol, such as the Internet Printing Protocol (IPP), or a protocol unique to a modeling apparatus vendor can be employed. The execution state information includes, for example, information indicating whether modeling for the modeling job is completed, information indicating up to which layer the modeling has progressed during execution thereof, remaining amount information about a consumable material, and information indicating whether sensors and driving components are operating normally.

In step S607, the job management module 305 determines whether the modeling job has ended based on the execution state information acquired in step S606. If the job management module 305 determines that the modeling job has ended (YES in step S607), the processing proceeds to step S608, and, if the modeling job has not yet ended, i.e., if the job is not yet executed or is being executed (NO in step S607), the processing returns to step S606.

In step S608, the job management module 305 determines whether an error has occurred in the modeling apparatus 102 at the end of the modeling job based on the execution state information acquired in step S606. For example, in a case where the status information indicating running out of consumable material is included in the execution state information or in a case where information indicating the occurrence of an abnormality in a sensor or driving component is included in the execution state information, the job management module 305 determines that an error has occurred in the modeling apparatus 102 during execution of the job (YES in step S608), and the processing then proceeds to step S609. In a case where the job management module 305 determines that error information is not included in the execution state information and information indicating the completion of modeling is included in the execution state information, the job management module 305 determines that the modeling job has been normally executed (NO in step S608), and the processing then ends. At this time, the job management module 305 stores the execution result information about the job together with the error information in the modeling job management table 406.

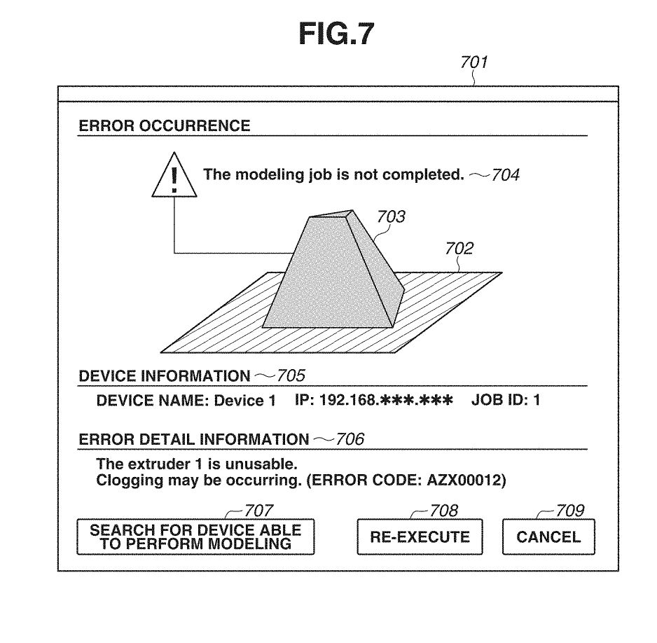

In step S609, the UI module 302 displays an error information screen indicating that the modeling job is not completed. For example, an error information screen UI for the modeling job illustrated in FIG. 7 is displayed. The error information screen UI includes a window 701 of the error information screen for the job. The error information screen UI further includes simulation images 702 and 703 of an object to be modeled. The simulation image 702 indicates a build plate of the modeling apparatus, and the simulation image 703 is used to three-dimensionally display the shape of an object to be modeled. At this time, the simulation image 703 can be a three-dimensional image obtained after modeling is completed or can be used to display a three-dimensional image of only a portion modeling of which is currently completed. The error information screen UI further includes an annotation display 704 indicating in which object in the modeling job or in which position in the object an error has occurred. The error information screen UI further includes a field 705 indicating modeling apparatus information and job information about the modeling apparatus in which the error has occurred. The modeling apparatus information is acquired from the device management table 401 and the modeling job management table 406. The error information screen UI further includes a field 706 indicating detail information about the occurred error, which is error information stored in the modeling job management table 406. At this time, in a case where the error information is a previously registered error, the field 706 indicates ancillary work relevant to the error. For example, in a case where an error resulting in replacement of consumable materials is detected, the UI module 302 can acquire consumable material replacement procedure information about the modeling apparatus 102 from the work instruction manual management table 407 and display the consumable material replacement procedure information on the screen. The user is allowed to select any one of the following operations based on the error information such as that illustrated in FIG. 7. The user selects a “search for device able to perform modeling” button 707 in the case of executing the job with another modeling apparatus, selects a “re-execute” button 708 in the case of re-executing the job with the modeling apparatus in which the error has occurred, or selects a “cancel” button 709 in the case of ending the job. When the UI module 302 detects that the “cancel” button 709 has been pressed, the flow illustrated in FIG. 6A and FIG. 5 ends.

Next, the description refers back to the flowchart of FIG. 6A.

If, in step S610, the UI module 302 detects that the “re-execute” button 708 has been pressed in the error information screen UI displayed in step S609 (YES in step S610), the processing returns to step S602, so that the job is re-executed. If the “re-execute” button 708 is not pressed (NO in step S610), the processing proceeds to step S611. If, in step S611, the UI module 302 detects that the “search for device able to perform modeling” button 707 has been pressed (YES in step S611), the processing illustrated in FIG. 6A returns to the flow illustrated in FIG. 5, so that the processing proceeds to step S503. If the UI module 302 does not detect such event, in other words, detects that the “cancel” button 709 has been pressed (NO in step S611), the processing illustrated in FIG. 6A and FIG. 5 ends. Thus far is the description made with reference to FIG. 6A.

The description refers back to the flowchart of FIG. 5.

In step S503, the device switching module 306 searches for alternative modeling apparatuses that are able to alternatively execute the job executed in step S502, provides a list of alternative modeling apparatuses to the user, and performs processing for prompting the user to select an alternative modeling apparatus 105. Details of the alternative device search processing are described with reference to the sub-flow illustrated in FIG. 6B.

In step S651, the device switching module 306 acquires network address information about modeling apparatuses from the device management table 401 of the data management module 308. At this time, the device switching module 306 can search for modeling apparatuses connected to the network 101 using the broadcast or multicast protocol of TCP/IP. Naturally, the device switching module 306 can search for modeling apparatuses on the network 101 using a network protocol unique to a modeling apparatus vendor.

In steps S652 to S655, processing in steps S653 and S654 is performed on each modeling apparatus acquired in step S651. When the processing on all of the modeling apparatuses ends, the loop ends.

In step S653, the device management module 304 acquires performance information about a modeling apparatus from the configuration management module 324 of the modeling apparatus 102. The performance information includes, for example, items such as the maximum modeling size, stacking pitch width, maximum head movement speed, and consumable material information, which are managed with the above-mentioned device performance information management table 405. Besides, the performance information can include, for example, performance information about an option device connected to a modeling apparatus, such as the presence or absence of a removal device for a support or the presence or absence of a paint treatment function. Naturally, other performance information can be managed with the device performance information management table 405 as long as it is information related to the performance of a modeling apparatus. The performance information is acquired by using a common standard protocol, such as Internet Printing Protocol (IPP), or a protocol unique to a modeling apparatus vendor. With regard to a modeling apparatus that does not conform to network connection, the performance information can be acquired via a driver for the modeling apparatus with the use of, for example, a Universal Serial Bus (USB) or serial port.

In step S654, the device switching module 306 compares the modeling setting information about the modeling apparatus acquired in step S602 and the performance information about the alternative modeling apparatus 105 acquired in step S653, and determines whether the above-mentioned modeling setting information is able to be applied to the alternative modeling apparatus 105. In a case where a value of the modeling setting information is within the range of values of the performance information with respect to a predetermined item, the device switching module 306 determines that the setting in question is able to be applied to the alternative modeling apparatus.

Specific examples in which it is determined that the modeling setting is not applicable include a case in which the modeling setting size of the job exceeds the maximum modeling size of the alternative modeling apparatus 105 and a case in which the stacking pitch setting of the job is a value outside of the applicable range of the alternative modeling apparatus 105. Moreover, for example, in a case where the type of a consumable material set to the job is different from a consumable material set in the alternative modeling apparatus 105, it is also determined that the modeling setting is not applicable. Furthermore, in a case where a consumable material runs short when modeling is performed by the alternative modeling apparatus 105, instruction manual data concerning an ancillary work for the setting is acquired from the work instruction manual management table 407. Moreover, in a case where ancillary work occurs before and after modeling, such as activation of firmware, initial position setting of a build plate, or adjustment of in-chassis temperature, with respect to the alternative modeling apparatus 105, instruction manual data concerning the ancillary work is also acquired.

If, in step S655, it is determined that the processing in steps S652 to S655 has been performed on all of the modeling apparatuses registered with the client application 301, the processing proceeds to step S656. If t is determined that the processing has not been performed on all of the modeling apparatuses, the processing returns to step S652, so that the processing in step S653 is performed on the remaining modeling apparatuses.

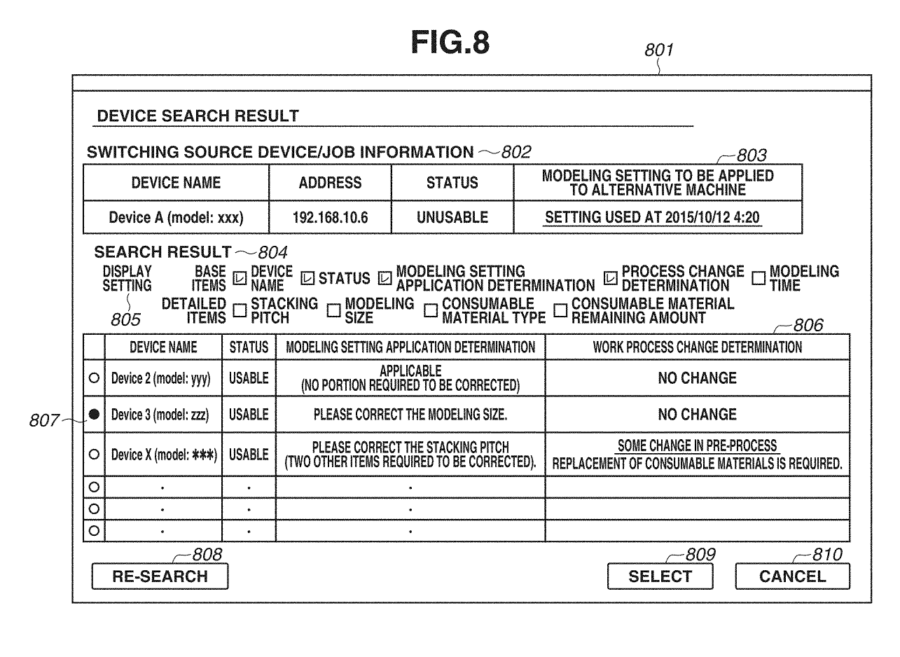

In step S656, the UI module 302 performs control to display a result of the processing in steps S652 to S655 performed on each modeling apparatus as a modeling apparatus list screen. For example, a modeling apparatus list screen UI illustrated in FIG. 8 is displayed. The modeling apparatus list screen UI includes a window 801 for the modeling apparatus list screen provided by the client application 301. Information about a modeling apparatus that has failed in executing the job is displayed in a field 802. The information about a modeling apparatus displayed in the field 802 includes information about a modeling apparatus in which an error has occurred in steps S604 and S608 and modeling setting included in the executed job, such as those to be managed with the device management table 401 and the modeling setting management table 402.

The modeling apparatus list screen UI further includes a field 804 indicating a search result of modeling apparatuses searched for in steps S651 to S655. The field 802 includes information 803 concerning a modeling apparatus in which an error has occurred in steps S604 and S608 and modeling setting included in the executed job, which is displayed in tabular form. The field 804 includes display setting 805 for the search result of modeling apparatuses. For example, the display setting 805 includes information about, for example, the device name, status, modeling setting application determination, process change determination, modeling time, stacking pitch, modeling size, consumable material type, and consumable material remaining amount of a modeling apparatus. The user is allowed to select a plurality of items to be displayed, so that optional items can be displayed.

The field 804 further includes a table 806 indicating the modeling apparatuses searched for in steps S651 to S655. Examples of items displayed in the table 806 include information about the device name, status, modeling setting application determination, and work process change determination. Here, the status is an item indicating whether a modeling apparatus is usable, and displays, for example, “usable” if the modeling apparatus is usable and “unusable” if the modeling apparatus is unusable based on the modeling apparatus performance information acquired in step S653. Naturally, the status can be of another type of description as long as it is a description indicating whether a modeling apparatus is usable. Moreover, in a case where a modeling apparatus becomes usable after a specific work, such as replacement of consumable materials, is performed, a message indicating that effect can be displayed.

The modeling setting application determination is an item indicating whether the modeling setting of the job received in step S501 is able to be applied to the alternative modeling apparatus 105. Here, the modeling setting is setting information associated with a job and a modeling apparatus which are stored in the modeling setting management table 402. The method for displaying in the modeling setting application determination includes, for example, in a case where the modeling size of the job received in step S501 exceeds the size available for modeling by the alternative modeling apparatus 105, providing a display for prompting the user to change the modeling size, such as “please correct the modeling size”. Another display or notification method can be employed for indicating a change of the modeling setting and indicating to which item a change of the modeling setting is made.

The work process change determination is an item indicating the presence or absence of a work process associated with a change of the modeling apparatus and the work content. For example, in a case where the type of a consumable material set in the alternative machine is different from the type of a consumable material set in the job received in step S501, a display for prompting the replacement of consumable materials is provided as “some change in pre-process”. The replacement procedure for consumable materials can include acquiring instruction manual data corresponding to a process from the work instruction manual management table 407 and displaying the content thereof. Furthermore, while the replacement of consumable materials is taken as an example of a process change, the extraction of an object or the removal of waste liquid can be made as an example depending on a change of the modeling method. Naturally, other work process information can be displayed or transmitted to the user as long as it is information concerning a work process made according to a change of the modeling apparatus.

Radio buttons 807 are used to select an optional alternative modeling apparatus 105. The user selects the radio button of an optional alternative modeling apparatus 105 and presses a “select” button 809, thus advancing the processing. A “re-search” button 808 is used to re-search for a modeling apparatus able to perform alternative execution of the job. A “cancel” button 810 is also displayed, and when detecting that the “cancel” button 810 is pressed, the UI module 302 determines that alternative execution processing of the job is canceled by the user, so that the flow illustrated in FIG. 5 and FIG. 6B ends. Thus far is the description made with reference to FIG. 8.

The description refers back to the sub-flow illustrated in FIG. 6B.

If, in step S657, the UI module 302 detects that the “re-search” button 808 is pressed (YES in step S657), the processing returns to step S651, so that search processing for modeling apparatuses is re-performed. If the UI module 302 detects that the “re-search” button 808 is not pressed (NO in step S657), the processing proceeds to step S658. If, in step S658, the UI module 302 detects that the “select” button 809 is pressed (YES in step S658), the flow illustrated in FIG. 6B returns to the flow illustrated in FIG. 5, so that the processing proceeds to step S504. If the UI module 302 detects that the “select” button 809 is not pressed, i.e., the “cancel” button 810 is pressed (NO in step S658), the flow illustrated in FIG. 6B and FIG. 5 ends.

The description refers back to the flowchart of FIG. 5.

In step S504, the device switching module 306 for modeling apparatuses determines whether to make a change of the modeling setting of the job based on information concerning whether the modeling setting of the job is applicable determined in step S654. Determination of whether to make a change of the modeling setting can be performed based on the presence or absence of a portion to be corrected in the modeling setting application determination mentioned above in the item 806 illustrated in FIG. 8. For example, in a case where there are one or more portions to be corrected, the device switching module 306 determines to make a change of the modeling setting, and, in a case where there is no portion to be corrected, the device switching module 306 determines not to make a change of the modeling setting. If the device switching module 306 determines to make a change of the modeling setting (YES in step S504), the processing proceeds to step S505, and if the device switching module 306 determines not to make a change of the modeling setting (NO in step S504), the processing proceeds to step S508.

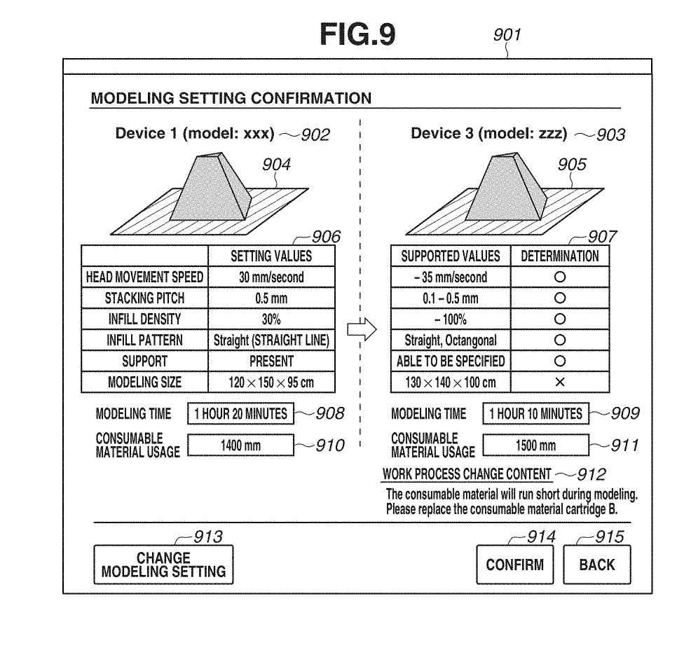

In step S505, the UI module 302 performs control to display a screen used to confirm or correct the modeling setting of the job. For example, a modeling setting confirmation and correction screen UI illustrated in FIG. 9 is displayed.

A window 901 is displayed for the modeling setting confirmation and correction screen. Information about the modeling apparatus in which an error has occurred in step S502 is displayed at the left-hand portion 902 of the screen. Information about the alternative modeling apparatus that alternatively executes the job is displayed at the right-hand portion 903 of the screen.

A simulation image 904 of an object included in the job that has failed in execution in step S502 is displayed. A simulation image 905 of an object in a case where the job that has failed in execution in step S502 is executed by the modeling apparatus selected in step S658 is also displayed. Modeling setting of the modeling apparatus selected in step S658 is reflected in the displayed simulation image 905. For example, in a case where the scale size setting of the object is changed to a smaller value, the display size of the object of the simulation image 905 is set smaller than the display size of the object of the simulation image 904. This enables the user to comprehend a change of the shape of the modeled object associated with a change of the setting.

Modeling setting values 906 of the job that has failed in execution in step S502 are displayed. A determination result 907 of whether the modeling setting is applicable acquired in step S654 is also displayed. The determination result can be expressed by a circle (applicable) and a cross (not applicable) or can be expressed by other messages or icons. An estimated modeling time 908 of the job that has failed in execution in step S502 is displayed. An estimated modeling time 909 in which the new modeling setting is reflected at the modeling apparatus selected in step S658 is also displayed. Displaying the estimated modeling times 908 and 909 enables the user to comprehend the time used for modeling and a difference in the time usage. An estimated usage 910 of the consumable material of the job that has failed in execution in step S502 is displayed. A consumable material usage 911 in which the new modeling setting is reflected at the modeling apparatus selected in step S658 is also displayed. Furthermore, only any one of the estimated modeling time and the estimated consumable material usage can be displayed.

Work process information 912 in executing the job at the modeling apparatus selected in step S658 is displayed. The work process information is an item indicating the presence or absence of a work process associated with a change of the modeling apparatus and the work content thereof. For example, in a case where the type of a consumable material set in the alternative machine is different from the type of a consumable material set in the job received in step S501, a display for prompting the replacement of consumable materials is provided as “some change in pre-process”. The replacement procedure for consumable materials can include acquiring instruction manual data corresponding to a process from the work instruction manual management table 407 and displaying the content thereof.

Furthermore, while the replacement of consumable materials is taken as an example of a process change, the extraction of an object or the removal of waste liquid can be used as an example depending on a change of the modeling method. Naturally, other work process information can be displayed or transmitted to the user as long as it is information concerning a work process according to a change of the modeling apparatus. A “change modeling setting” button 913 is a button used to change the modeling setting of the job to be applied to the alternative modeling apparatus 105. A “confirm” button 914 is a button used to start executing the job with the selected alternative modeling apparatus 105 and the corrected modeling setting. When detecting that a “back” button 915 is pressed, the UI module 302 displays a selection screen for the alternative modeling apparatus 105 illustrated in FIG. 8 to the user.

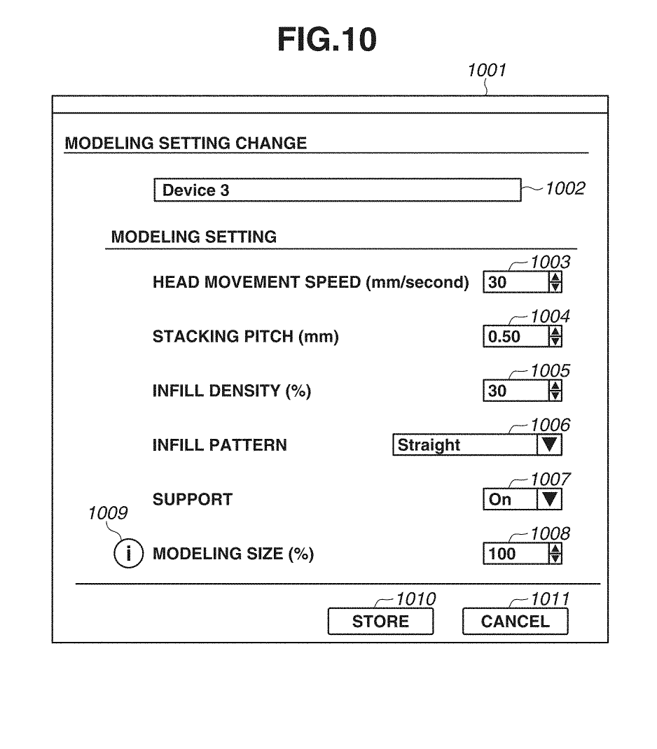

Here, an example of an input screen UI for modeling setting, which is displayed by the UI module 302 when the “change modeling setting” button 913 is pressed, is illustrated in FIG. 10. When the input screen illustrated in FIG. 10 is displayed, the setting values 906 illustrated in FIG. 9 are reflected and displayed therein.

A window 1001 is displayed for the input screen for modeling setting, which is provided by the client application 301. Information 1002 for specifying a modeling apparatus as a target for setting change is displayed. An item 1003 is used to set a value (mm/sec) of the movement speed of a head that outputs a consumable material. An item 1004 is used to set a value (mm) of the stacking pitch. An item 1005 is used to set a value (%) of the infill density. A pull-down menu 1006 is used to set an infill pattern. An item 1007 is used to set the presence or absence of a support.

An item 1008 is used to set the size (%) of an object to be modeled. An indication 1009 is displayed to prompt the user to make a change to an item that is determined not to be applicable in the determination result 907 illustrated in FIG. 9. For example, when the user selects the indication 1009, a display for prompting the user to set the modeling size to a value equal to or less than 93%. Furthermore, the method for displaying, for example, the change content is not limited to this. Moreover, instead of the percent of the size of an object, numerical values of width, depth, and height thereof can be input to the item 1008.

The modeling setting is supposed to include at least one of the movement speed of a head, the stacking pitch, the infill density, and the infill pattern. Furthermore, the user is allowed to change the value of an item that is applicable. A “store” button 1010 is used to store various setting values in the items 1002 to 1008. When detecting that the “store” button 1010 is pressed, the UI module 302 stores the various setting item values in the data management module 308. Moreover, when detecting that a “cancel” button 1011 is pressed, the UI module 302 returns the current screen to the modeling setting confirmation screen illustrated in FIG. 9. Furthermore, the screens illustrated in FIG. 9 and FIG. 10 can be displayed in a single screen, or, in response to the “select” button 809 illustrated in FIG. 8 being pressed, the screen illustrated in FIG. 8 can be shifted to the screen illustrated in FIG. 10 for changing the setting values. Thus far is the description made with reference to FIG. 10.

Next, the description refers back to the flowchart of FIG. 5.

If, in step S506, the UI module 302 detects that the “confirm” button 914 is pressed (YES in step S506), the processing proceeds to step S507. If the UI module 302 detects that the “confirm” button 914 is not pressed, i.e., the “back” button 915 is pressed (NO in step S506), the processing returns to step S503, so that search processing for modeling apparatuses is re-performed.

In step S507, the device switching module 306 acquires status information about the alternative modeling apparatus 105 and determines whether the job is able to be executed with the modeling setting set in step S505. More specifically, in a case where the modeling setting value of the job exceeds the value (threshold value) of the alternative modeling apparatus 105 managed with the device performance information management table 405, the device switching module 306 determines that the job is not able to be executed (NO in step S507), and the processing then returns to step S505. In a case where the modeling setting is set to a value supported by the alternative modeling apparatus 105, the device switching module 306 determines that the job is able to be executed (YES in step S507), and the processing then proceeds to step S508.

In step S508, the job management module 305 instructs the control instruction generation module 307 to generate a job for modeling an object. The job generated by the control instruction generation module 307 is transmitted to the alternative modeling apparatus 105 via the network module 309 at optional timing. The alternative modeling apparatus 105 performs object modeling according to the received job. Furthermore, the job management module 305 can include the function to transmit the generated job to the modeling apparatus 102. The job contains a control instruction for modeling an object targeted for modeling. The method for transmitting the job can include transmission of the job using the above-mentioned network 101 and transfer using serial connection, such as USB. Moreover, in a case where the 3D printer is a machine conforming to an external memory, such as a USB memory, job information can be output to such an external memory. The format of the job information to be output is a format that is readable by a dedicated application (for example, xml or json).

Thus far is the description made with reference to the flowchart of FIG. 5.

According to the present exemplary embodiment, in a case where a specific modeling apparatus has become unusable, a method for providing an appropriate alternative machine to perform modeling without making a change to data of an object and a procedure for displaying, to the user, ancillary work associated with a change of the modeling apparatus for modeling can be provided.

Furthermore, the computer 103 can provide screens illustrated in, for example, FIGS. 7 to 10 to another computer (not illustrated), and these screens can be displayed by that computer. Here, examples of the computer include a personal computer (PC), a tablet computer, and a smartphone.

In the above first exemplary embodiment, an example has been described in which, in a case where a specific modeling apparatus has become unusable, a method for providing an appropriate alternative machine to perform modeling without making a change to data of an object and a procedure for displaying, to the user, ancillary work associated with a change of the modeling apparatus for modeling are provided.

In a second exemplary embodiment, a method for selecting an optional job from an execution history of past jobs and searching for a modeling apparatus that is able to re-execute the job is described. For example, the present exemplary embodiment is applicable to a case where, when the user intends to re-execute a job that was executed in the past, the user is previously aware that a modeling apparatus that was used for the job is unusable due to, for example, maintenance.

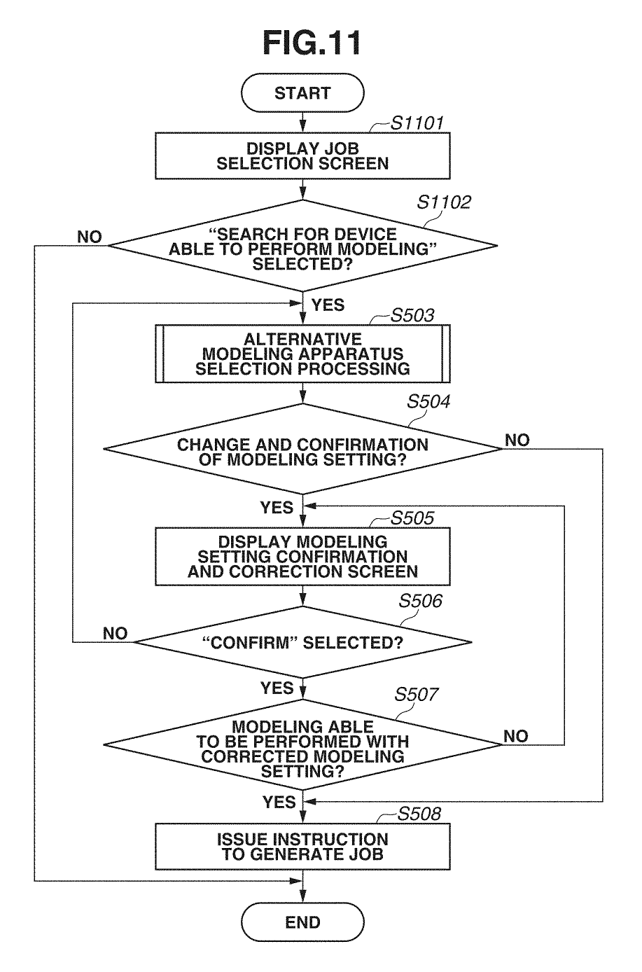

FIG. 11 is a flowchart illustrating the flow of processing performed by the client application 301. Processing in steps S503 to S508 is similar to that illustrated in FIG. 5, and the description thereof is, therefore, omitted. Processing in the flowchart of FIG. 11 is implemented by the CPU 201 reading out a program recorded in the ROM 203 or the external memory 211 and executing the program.

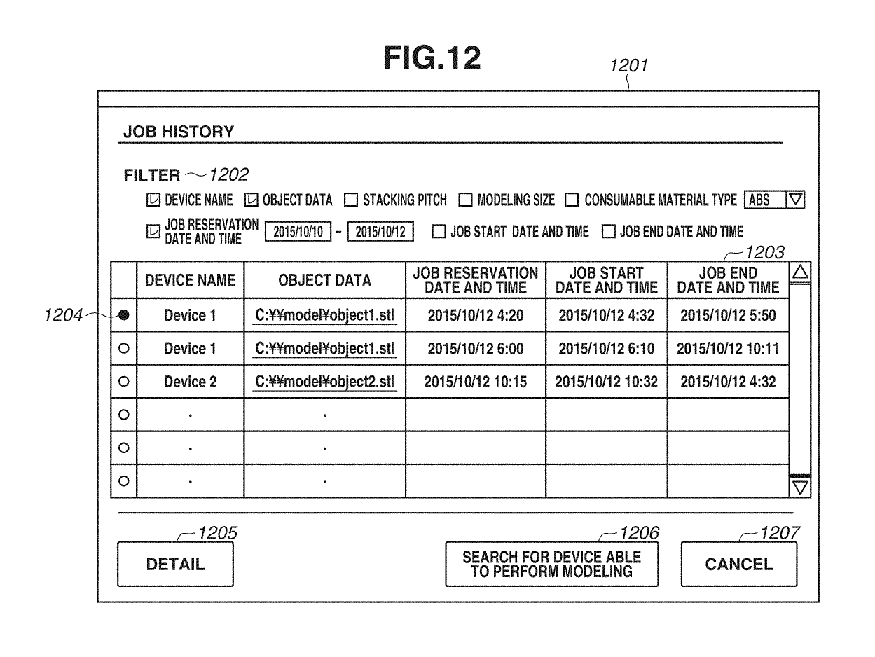

In step S1101, the UI module 302 displays a job selection screen. For example, a job selection screen UI illustrated in FIG. 12 is displayed. The job selection screen UI can be displayed immediately after the client application 301 is activated, or can be displayed in response to a GUI operation by the user at optional timing for the user.

A window 1201 is displayed for the job selection screen. Setting items 1202 are used to narrow down the job history. The setting items include, for example, the name of a device that executed a job, file path information about object data included in the job, stacking pitch setting of the job, modeling size of the job, consumable material type of the job, job reservation date and time, job start date and time, and job end date and time. Here, with regard to the consumable material type, an optional consumable material type, such as ABS or PLA, can be selected via, for example, a pull-down menu. Moreover, dates in the job reservation date and time, job start date and time, and job end date and time can be displayed by specifying a period. The user is allowed to cause optional items to be displayed by selecting a plurality of items to be displayed.

A list 1203 of job history information about jobs that were executed by the client application 301 in the past is displayed. The job history information is acquired from tables, such as the device management table 401, the modeling setting management table 402, the object management table 404, and the modeling job management table 406, of the data management module 308 according to the display setting in the setting items 1202. For example, in a case where a display period of the job reservation date and time is set in the setting items 1202, job information concerning the specified display period is searched for from the modeling job management table 406, and information about the job is acquired from the relevant tables. Naturally, a job list in the list 1203 of job history information can be filtered by other display setting.

Radio buttons 1204 are used to select an optional job. The user selects the radio button of an optional job and presses a “search for device able to perform modeling” button 1206, thus advancing the processing. A button 1205 is a “detail button” used to display detail information about the optional job selected by the user. When detecting that the “detail” button 1205 is pressed, the UI module 302 displays detail setting value information about the job selected by the radio button 1204. At this time, the detail setting value information can be displayed in the same window as the window 1201, or can be displayed in another window. Specific examples of a screen for the detail setting value information include a UI such as that illustrated in FIG. 10 described above. However, a change of setting information cannot be made here.

A “cancel” button 1207 is also displayed, and when detecting that the “cancel” button 1207 is pressed, the UI module 302 determines that the user operation ends, so that the flow illustrated in FIG. 11 ends. Thus far is the description made with reference to FIG. 12.

If, in step S1102, the UI module 302 detects that the “search for device able to perform modeling” button 1206 is pressed (YES in step S1102), the processing proceeds to step S503. If the UI module 302 detects that the “search for device able to perform modeling” button 1206 is not pressed, i.e., the “cancel” button 1207 is pressed (NO in step S1102), the processing illustrated in FIG. 11 ends.

According to the present exemplary embodiment, the user is enabled to select an optional job from a job execution history of jobs that were executed in the past and search for a modeling apparatus able to re-execute the job.

In the above first exemplary embodiment, an example has been described in which, in a case where a specific modeling apparatus has become unusable, a method for providing an appropriate alternative machine to perform modeling without making a change to data of an object and a procedure for displaying, to the user, ancillary work associated with a change of the modeling apparatus for modeling are provided. Moreover, in the above second exemplary embodiment, a method for selecting an optional job from a job execution history of jobs that were executed in the past and searching for a modeling apparatus able to re-execute the job has been described.

In a third exemplary embodiment, in a case where an ancillary work associated with a change of the modeling apparatus occurs, a method for displaying the ancillary work to the user and providing an interface capable of acquiring the content of the ancillary work in a data format is described. Examples of the ancillary work include a re-adjustment work for a build plate prior to modeling, replacement of a waste material or waste fluid in the modeling apparatus, and cleaning after modeling. Since most high-end model modeling apparatuses have a complicated mechanism, the user may want to perform the above-mentioned ancillary work while confirming the procedure thereof via, for example, a manual. As mentioned above, the present exemplary embodiment is applicable in outputting, for example, a manual for an ancillary work that occurs in association with a change of the modeling apparatus.

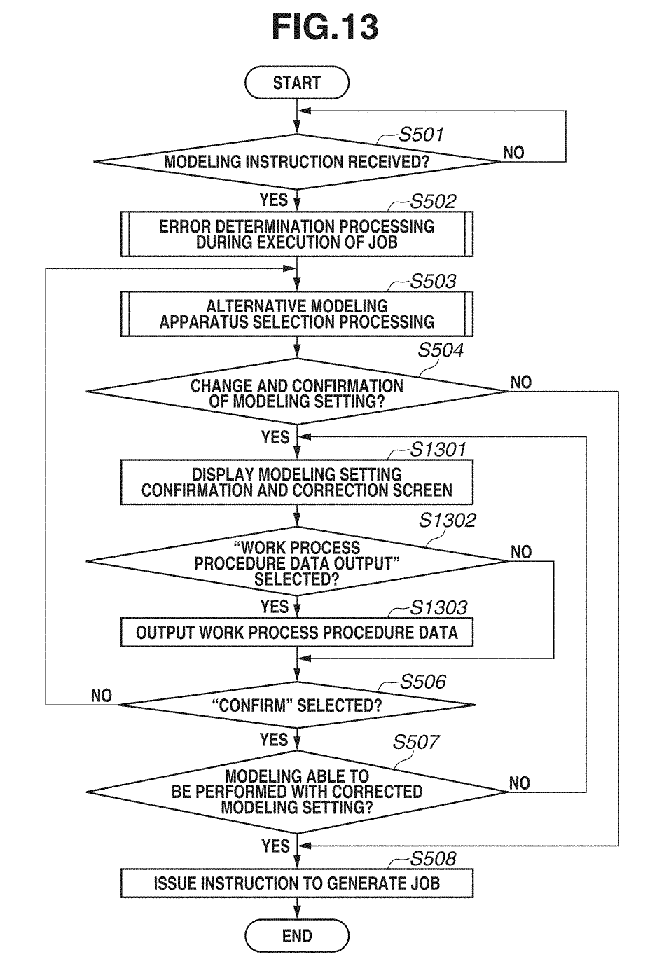

FIG. 13 is a flowchart illustrating the flow of processing performed by the client application 301. Processing in steps S501 to S504 and steps S506 to S508 is similar to that illustrated in FIG. 5, and the description thereof is, therefore, omitted. Processing in the flowchart of FIG. 13 is implemented by the CPU 201 reading out a program recorded in the ROM 203 or the external memory 211 and executing the program.

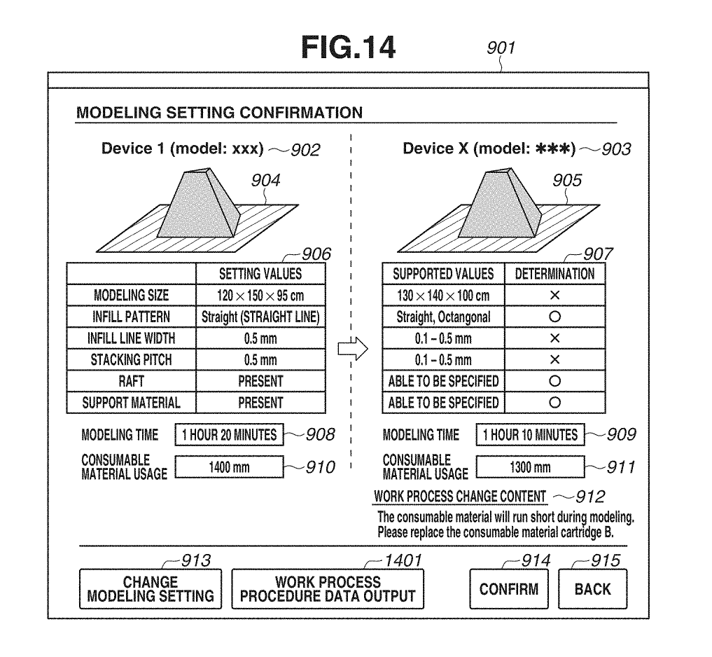

In step S1301, the UI module 302 displays a screen for confirming and correcting modeling setting of a job. For example, a modeling setting confirmation and correction screen UI illustrated in FIG. 14 is displayed. Items 901 to 915 are similar to those illustrated in FIG. 9, and the description thereof is, therefore, omitted.

A “work process procedure data output” button 1401 is a button used for the user to acquire the work process content displayed in the item 912 and work procedure data about a modeling apparatus concerning the work process. Here, the work process procedure data is instruction manual data about each modeling apparatus, such as that managed with the work instruction manual management table 407. When detecting that the “work process procedure data output” button 1401 is pressed, the UI module 302 transmits the work process procedure data to the user, so that the user can optionally download the above data. The data format of the work process procedure data is, for example, a hyper-text format, such as html, or a text file. Naturally, another unique data format can be employed as long as it is the format that is viewable by the user. Thus far is the description made with reference to FIG. 10.

Next, the description refers back to the flowchart of FIG. 13.

If, in step S1302, the UI module 302 detects that the “work process procedure data output” button 1401 is pressed (YES in step S1302), the processing proceeds to step S1303. If the UI module 302 detects that the “work process procedure data output” button 1401 is not pressed (NO in step S1302), the processing proceeds to step S506.

In step S1303, the device switching module 306 acquires instruction manual data related to the ancillary work from the work instruction manual management table 407, integrates the data, and transmits the work process procedure data to the user. The user is allowed to optionally download the above data.

According to the present exemplary embodiment, in a case where an ancillary work associated with a change of the modeling apparatus occurs, the ancillary work can be displayed to the user and an interface capable of acquiring the content of the ancillary work in a data format can be provided.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors and one or more memories (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-048863 filed Mar. 11, 2016, which is hereby incorporated by reference herein in its entirety.

What is claimed is:

1. An information processing apparatus configured to manage information about a plurality of modeling apparatuses each of which models a three-dimensional object, the information processing apparatus comprising:
one or more processors; and
one or more memories storing a program which,
when executed by the one or more processors, causes the information processing apparatus to:
acquire setting information indicating a setting for modeling to a modeling apparatus having received an instruction for modeling of an object;
acquire performance information indicating a function concerning modeling that is able to be provided by an alternative modeling apparatus other than the modeling apparatus having received the instruction;
determine whether the setting for modeling indicated by the acquired setting information is able to be applied to the alternative modeling apparatus based on the acquired performance information about the alternative modeling apparatus in order to cause the alternative modeling apparatus to model the object concerning the instruction; and
control displaying of information indicating a result of determining whether the setting for modeling is able to be applied to the alternative modeling apparatus,
wherein, if determining that the setting for modeling is not able to be applied to the alternative modeling apparatus, the information processing apparatus controls displaying of information about the setting for modeling that is not able to be applied to the alternative modeling apparatus.

2. The information processing apparatus according to claim 1, wherein, if determining that the setting for modeling is not able to be applied to the alternative modeling apparatus, the information processing apparatus changes the setting for modeling to be applied to the alternative modeling apparatus.

3. The information processing apparatus according to claim 1,
wherein each of the setting information and the performance information includes a plurality of items,
wherein, if a value of a predetermined item included in the acquired setting information is within a range of values of the predetermined item included in the acquired performance information about the alternative modeling apparatus, the information processing apparatus determines that a setting for modeling regarding the predetermined item is able to be applied to the alternative modeling apparatus, and
wherein, if a value of a predetermined item included in the acquired setting information is not within a range of values of the predetermined item included in the acquired performance information about the alternative modeling apparatus, the information processing apparatus determines that a setting for modeling regarding the predetermined item is not able to be applied to the alternative modeling apparatus.

4. The information processing apparatus according to claim 3, wherein the plurality of items includes at least one of a movement speed of a head that outputs a consumable material, a stacking pitch indicating a stacking width of a modeling material that is output from the head, a shape of an internal structure of an object, and an infill density of the internal structure of the object.

5. The information processing apparatus according to claim 1, wherein the program, when executed by the one or more processors, further causes the information processing apparatus to:
determine whether, in modeling the object concerning the instruction with the alternative modeling apparatus, there is a change in pre-processing, which is a work performed before modeling, or post-processing, which is a work performed after modeling; and
control displaying of information indicating a result of determining whether there is a change in the pre-processing or the post-processing.

6. The information processing apparatus according to claim 5, wherein, if determining that there is a change in the pre-processing or the post-processing, the information processing apparatus controls displaying of a work procedure of the pre-processing or the post-processing for modeling with the alternative modeling apparatus.

7. The information processing apparatus according to claim 5, wherein, if determining that a consumable material loaded in the alternative modeling apparatus is to be replaced, the information processing apparatus controls displaying for prompting a user to replace the consumable material.

8. The information processing apparatus according to claim 1, wherein the information processing apparatus controls displaying about at least one of a modeling time and a usage of a consumable material in a case where the object concerning the instruction is modeled by the alternative modeling apparatus with the setting for modeling applied to the alternative modeling apparatus.

9. The information processing apparatus according to claim 1,
wherein the information about a plurality of modeling apparatuses managed by the information processing apparatus includes history information about jobs for modeling that were previously executed, and
wherein the information processing apparatus selects an object targeted for modeling by the alternative modeling apparatus from the history information about jobs.

10. The information processing apparatus according to claim 1, wherein the information processing apparatus outputs, to an external memory, setting information indicating a setting for modeling that is applied to the alternative modeling apparatus in order to cause the alternative modeling apparatus to model the object concerning the instruction.

11. A control method for an information processing apparatus configured to manage information about a plurality of modeling apparatuses each of which models a three-dimensional object, the control method comprising:
acquiring setting information indicating a setting for modeling to a modeling apparatus having received an instruction for modeling of an object;
acquiring performance information indicating a function concerning modeling that is able to be provided by an alternative modeling apparatus other than the modeling apparatus having received the instruction;
determining whether the setting for modeling indicated by the acquired setting information is able to be applied to the alternative modeling apparatus based on the acquired performance information about the alternative modeling apparatus in order to cause the alternative modeling apparatus to model the object concerning the instruction; and
controlling displaying of information indicating a result of determining whether the setting for modeling is able to be applied to the alternative modeling apparatus,
wherein, if it is determined that the setting for modeling is not able to be applied to the alternative modeling apparatus, displaying of information about the setting for modeling that is not able to be applied to the alternative modeling apparatus is controlled.

12. A non-transitory computer-readable storage medium storing a computer program that, when executed by a computer, causes the computer to execute a control method for an information processing apparatus configured to manage information about a plurality of modeling apparatuses each of which models a three-dimensional object, the control method comprising:
acquiring setting information indicating a setting for modeling to a modeling apparatus having received an instruction for modeling of an object;
acquiring performance information indicating a function concerning modeling that is able to be provided by an alternative modeling apparatus other than the modeling apparatus having received the instruction;
determining whether the setting for modeling indicated by the acquired setting information is able to be applied to the alternative modeling apparatus based on the acquired performance information about the alternative modeling apparatus in order to cause the alternative modeling apparatus to model the object concerning the instruction; and
controlling displaying of information indicating a result of determining whether the setting for modeling is able to be applied to the alternative modeling apparatus,
wherein, if it is determined that the setting for modeling is not able to be applied to the alternative modeling apparatus, displaying of information about the setting for modeling that is not able to be applied to the alternative modeling apparatus is controlled.
